(19) United States
(12) Patent Application Publication
(10) Pub. No.: US 2009/0230217 A1
(43) Pub. Date: Sep. 17, 2009

(54) INSULATED CLEANING TOOL

(76) Inventor: Ronald K. Stone, Overland, MO (US)

Correspondence Address: SENNIGER POWERS LLP, 100 NORTH BROADWAY, 17TH FLOOR, ST LOUIS, MO, 63102, US

(21) Appl. No.: 12/404,724

(22) Filed: Mar. 16, 2009

Related U.S. Application Data
(60) Provisional application No. 61/036,532, filed on Mar. 14, 2008.

(51) Int. Cl. B05B 9/00

(52) U.S. Cl. 239/525

(57) ABSTRACT

A cleaning tool comprising a long thin body member having an upper valved end connectable to a pressurized source of cleaning fluid and having a closed lower end with a plurality of adjacent jet discharge ports, said body member being constructed and arranged with a first hand grip zone located at the upper end and a second hand grip zone located adjacent to the discharge ports, and the hand grip zones having an insulated safety covering.

### CROSS-REFERENCE TO RELATED APPLICATIONS

This is a non-provisional of U.S. application Ser. No. 61/036,532, filed Mar. 14, 2008, the entire disclosure of which is incorporated herein by reference.

### FIELD OF THE INVENTION

The present invention pertains generally to cleaning tools, and more particularly to tools for producing controlled high pressure fluidic jets for cleansing action.

### BACKGROUND OF THE INVENTION

A great number of nozzles and tools for producing pressurized cleaning action have been designed in the past for doing a variety of cleaning jobs. One of the most difficult and necessary cleaning tasks is that of air conditioning and refrigeration condenser coils, particularly of the type having closely spaced fins through which air passes to effect heat transfer. Obviously the accumulation of dirt and debris in outdoor condenser units clogs the air passages and coats the fin and coil surfaces which greatly reduce the capability for good heat exchange and efficient operation. My earlier U.S. Pat. No. 4,600,153 covered my basic cleaning tool configuration, and this tool is highly effective in condenser cleaning operations. However, despite safety warnings, users often do not turn off power to condensing units prior to initiating a cleaning function thereby endangering themselves to electric shock through the metal body of the tool. In addressing this safety problem it has been discovered that the functionality of my tool for use in many other household yard and automotive applications can also be enhanced in a simple and non-obvious way, and which also improves usage in the cleaning of cadavers in the mortuary business (as discussed in my '153 patent).

### SUMMARY OF THE INVENTION

The present invention pertains to cleaning tools for producing high and/or variable intensity fluidic cleansing action and is embodied in a tool having a long, thin body member with a liquid intake end and a remote outlet end having a plurality of jet openings for producing predetermined fluidic discharge patterns, and, further, pertains to insulation features that include protected hand placement zones for optimum safe control of the tool in varied uses.

The primary object of the present invention is to provide a simple, strong, durable, economical and efficient cleaning tool having a wide variety of useful applications.

Another object is to provide a cleaning tool having an insulated, wand-like body member that can easily be handled and manipulated to efficiently effect fluidic jet cleansing.

Another object is to provide a simple, yet efficient cleaning tool that is completely portable and connectable to available water sources or other pressurized fluids, and which provides protected hand positioning and at the same time can be regulated as to fluidic cleaning pressure.

Another object is to provide a cleaning tool useful for electrically powered fixtures and is safety insulated to protect careless users who are unmindful of safety instructions and may be subjected to electrical shock.

These and still other objects and advantages will become more apparent hereinafter.

### DESCRIPTION OF THE DRAWINGS

The invention is embodied in the parts and in the combinations and arrangements of parts hereinafter described and claimed. In the accompanying drawings which form a part of this specification and wherein like numerals refer to like parts wherever they occur:

FIG. 1 is a fragmentary front elevational view of an insulated cleaning tool embodying the present invention,

FIG. 2 is a greatly enlarged cross-sectional view taken substantially along line 2-2 of FIG. 1,

FIG. 3 is a greatly enlarged cross-sectional view taken substantially along line 3-3 of FIG. 1,

FIG. 4 is a perspective view of the cleaning tool embodying the present invention,

FIG. 5 is an enlarged fragmentary side elevational view of the cleaning tool, and

FIG. 6 is a diagrammatic cross-section illustrating a typical condenser cleaning operation using the tool.

### DESCRIPTION OF THE PREFERRED EMBODIMENT

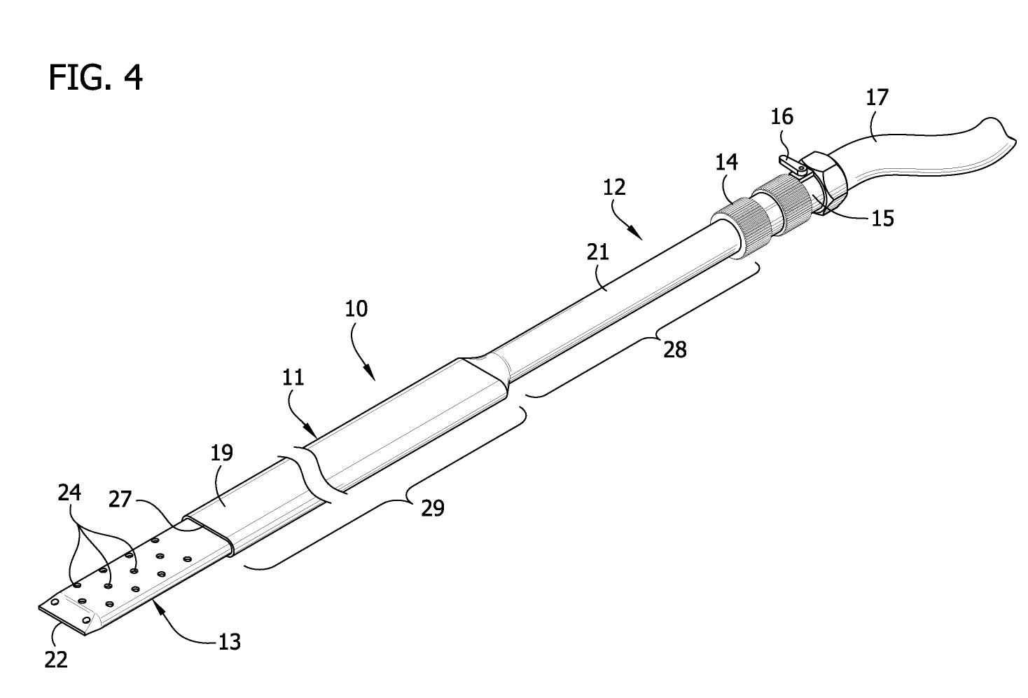

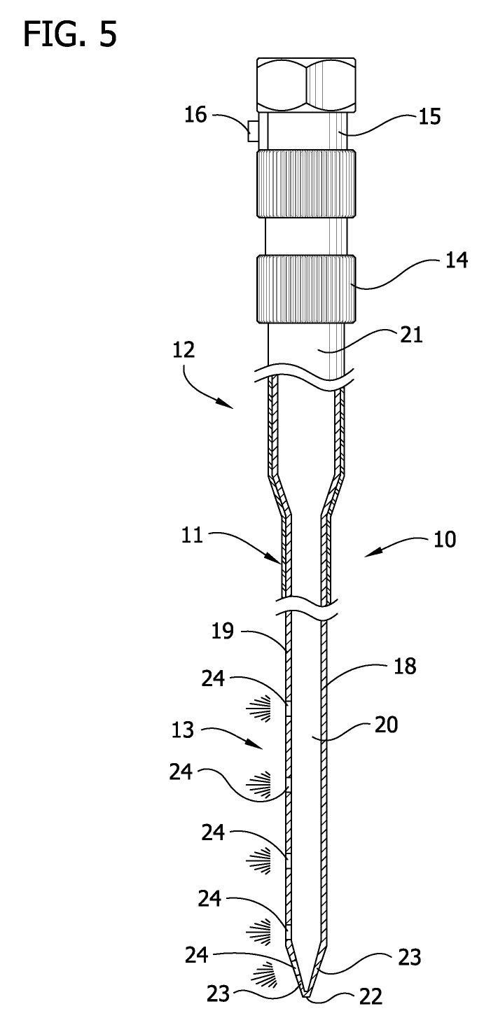

Referring now to the drawings, a cleaning tool 10 embodying the invention is illustrated, in which the tool 10 comprises a long main body 11 formed of aluminum conduit or like hollow, tubular material and having a fluid inlet section 12 at one end and a jet outlet section 13 at the other end. The fluid inlet end 12 has a non-metal fitting 14 of electrical insulating material adapted to connect the tool 10 to a fluid source (17), and has a valve member 15 with a control handle 16 by which the internal valve (not shown) may be entirely opened or closed to fluid flow or turned to regulate the volume of such flow. The tool 10 will work efficiently with different fluid cleaning mediums such as compressed air, carbon dioxide, and pressurized cleaning fluids such as carbon tetrachloride or the like, but a conventional city water hook-up is highly effective, economical, easy to use and always readily available. Thus, the tool 10 through valve 15 may be connected to a typical garden house 17 (FIG. 4).

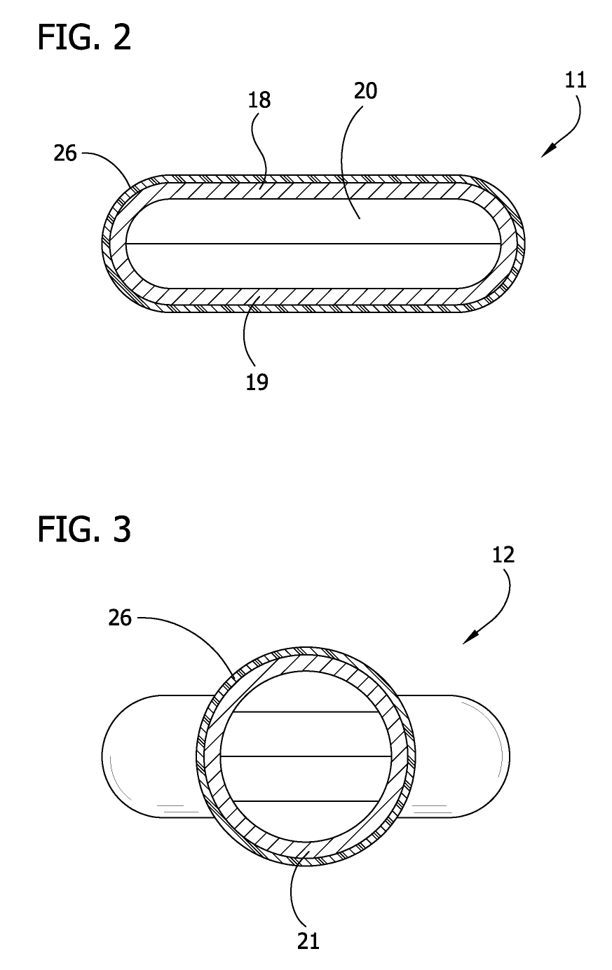

The main body section 11 of the tool is flattened throughout a major portion of its length so that opposed wall segments 18 and 19 (FIG. 2) have parallel surfaces and form a constricted interior passageway 20 leading to the outlet section 13 thereby creating a Venturi-type effect relative to the circular cross-sectional area 21 of the inlet section 12. The outlet end section 13 tapers from the flattened wall segments 18 and 19 to a sealed margin 23 closing the end section 13. In short, the convergence of the opposed wall segments define sloping wall sections 22 angularly related to the parallel flattened segments 18 and 19 and thus form a further constriction of the interior opening at the outlet end. An important feature of the tool resides in the construction and arrangement of jet ports or openings 24 in one of the flattened wall segments 23 and wall sections 19. The aggregate cross-sectional area of the discharge jet openings is less than the cross-sectional area of the constricted interior passage 20 of the tool 10 and thereby forms a final Venturi action on the discharge of cleaning fluid therethrough with the effect of increased velocity and decreased pressure.

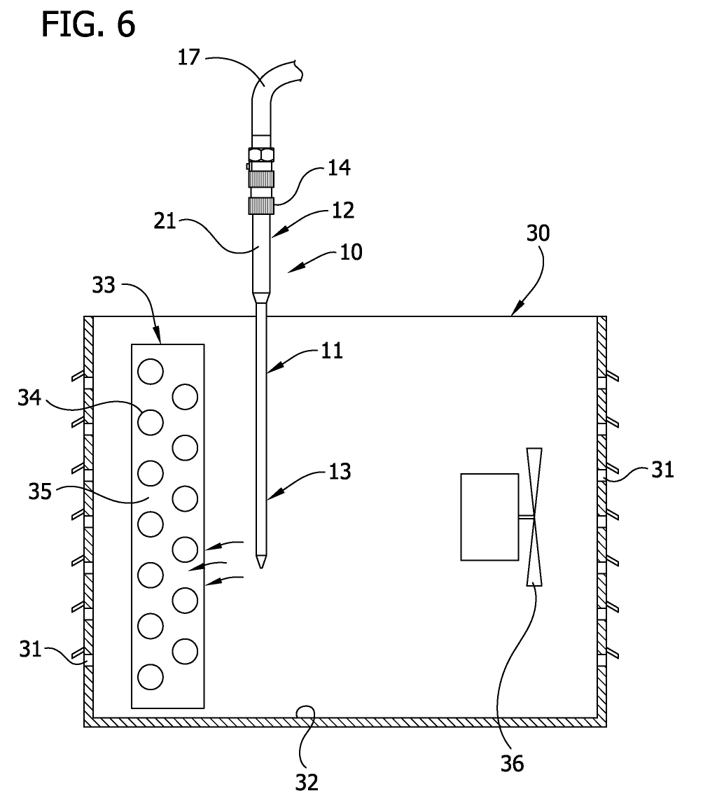

In a preferred embodiment the jet ports 24 are drilled or punched through the side wall 19 and are located in a predetermined pattern having three columns of openings and two of these columns are offset longitudinally from each other. The thickness of conduit wall 19 (18) can be a factor in determining the patterns of jet ports 24 since the fluid passage through the wall will become more directionalized if the wall is thicker (and the ports are longer). Therefore, the thicker the conduit material, the closer the ports should be to control convergence of the jet streams. In addition, the lowest or outer jet ports are located in wall section 23 immediately adjacent to the closed end margin and, preferably, are angularly drilled or punched in the wall to direct jet streams in a converging pattern as well as at a downward angle relative to the other jet streams discharged from upper openings 24. This arrangement produces a highly effective and concentrated sweeping or scrubbing action in certain applications, such as cleaning condenser coils as will be described with reference to FIG. 6.

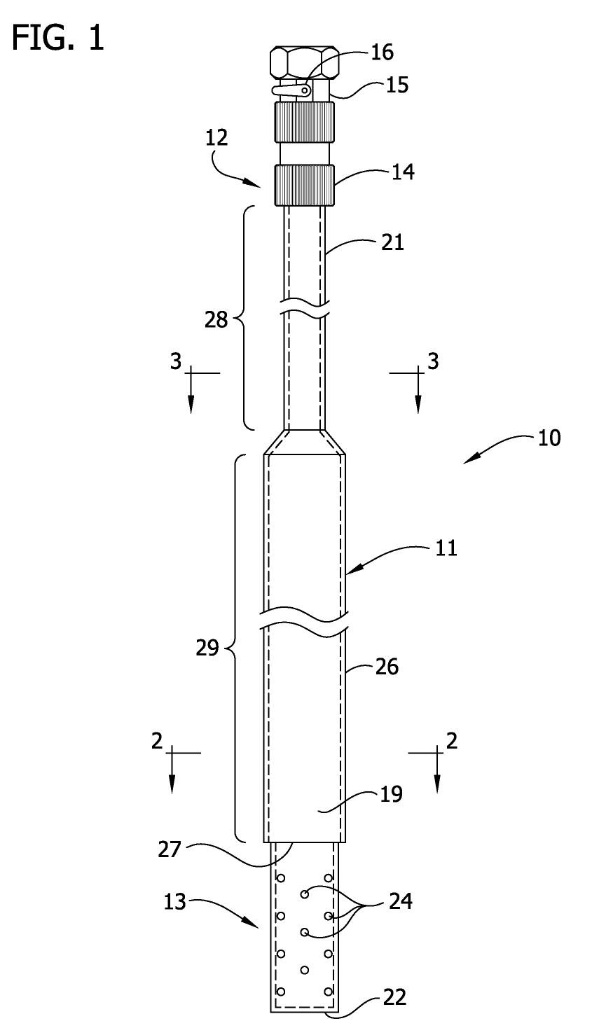

Referring particularly to FIGS. 1-4, the tool 10 of the present invention is greatly enhanced by having an electric-shielding coating or covering 26 encasing the main body section 11 and circular inlet section 12. It will be noted that the lower margin 27 of this casing 26 (FIGS. 1 and 4) is closely adjacent to the jet ports 24 at the outlet section 13, but is spaced away sufficiently so as not to interfere with the fluid jetting action. The body section 11 and inlet section 12 of the tool are encased to guard against electric shock in hazardous applications in which power has not been interrupted due to carelessness or the like. More especially the encasement 26 is constructed and arranged to accommodate efficient and protected handling of the tool in various applications. Thus the circular inlet section 12 is designed to form an elongated first or primary hand-grip zone 28 for one of the user's hands on the tool adjacent to the regulating intake valve 15, and the casing 26 extends from the non-metal (insulated) connector 14 to the flattened side wall sections 18 and 19 of the main body 11. A second or secondary hand-grip zone 29 extends a substantial length of the main body section 11 and accommodates a varied guiding hand placement along the body for the other of user's hands, and thereby safely optimizes selective hand placement depending on the cleaning application and fluidic pressurization needed therefore.

Referring to FIG. 6 of the drawings, a one typical air conditioning condenser coil and housing are diagrammatically shown in order to illustrate one typical operation of the cleaning tool 10. The condenser unit 30 includes a housing having vented side walls 31 and a bottom wall 32, and a top wall closure (not shown). The condensing unit 30 includes a condenser 33 having a serpentine coil 34 and closely spaced fins 35 providing heat exchange or transfer surfaces, and a fan 36 is provided to move ambient air through the condenser 33 to reduce the temperature of refrigerant in the coil 34 to its saturation temperature as a part of the typical refrigeration cycle. Through prolonged operation of the condensing unit 30, the fan 36 will draw dirt and debris into the housing and, since the air flow is baffled to pass entirely through the condenser 33, the coil 34 and fins 35 will catch or filter out this deleterious material and become clogged and coated so that heat transfer efficiency is substantially reduced. The operation of the cleaning tool 10 is as follows. The power to the unit 30 should be shut off, the cabinet top is removed and the fan motor is covered and shielded from the water or other cleansing fluid used. However it should be noted that impatient or careless workers or homeowners frequently fail to follow these basic first steps, and electric power is frequently left on. The cleaning tool 10 is connected to a pressurized fluid source (17), such as a city water tap (not shown) and the valve 15 is closed when this supply of water is turned on. It may be noted that the long, thin wand-like construction of the tool 10 creates a reaction force or “kick” at the closed end 22 due to the pressurized jet release. However, the wand construction permits easy control using two hands in the primary and secondary zones and the thinness of the tool is important in accessibility to all parts of the coil 34 and fins 35. The tool 10 is moved, starting at the top of the coil, back and forth progressing downwardly to free soil and back-flush the entire condenser clean. The jet discharge is directed counterflow to normal air flow during condenser cleaning operations so that the material is flushed free rather than being driven into and wedged further between fins 35. The jet pattern is predetermined to concentrate the water force on the fin surfaces and the lower or outer converging jets 24 efficiently pre-clean and wash debris downwardly ahead of the direct sweeping motion, and ultimately scrub and flush debris along the bottom wall 32 of the housing where it can be collected and removed.

It is manifest that the cleaning tool 10 is highly efficient and simple in its operation of cleaning surfaces and flushing into cracks and crevices. The extended length of the secondary hand-grip zone 29 and smooth outer surface of the casing 26 permits rapid and safe hand transference as needed to manipulate the tool for efficient cleaning. The special use of this cleaning tool 10 in the mortuary field for cleaning bodies may seem unusual, but is highly efficient with a minimum of effort and distasteful handling. In this application the tool 10 operates better at lower pressures which may be provided by longer jet-holes 24 or lowered water pressure.

It will also be apparent that varied vehicle and building structure applications may require different secondary hand zone control. Clearly the closeness of the second hand placement to the discharge end 13 will determine the amount of control of the wand 10.

The invention is intended to include all changes and modifications which will be readily apparent to those skilled in the art, and is only limited by the scope of the claims which follow.

What is claimed is:

1. A cleaning tool comprising:
a long thin body member having an upper end with a control valve for attachment to a pressurized source of cleaning fluid, and having a closed lower end with a plurality of adjacent fluid jet discharge ports,
said body member having a first hand grip zone located in the upper end adjacent to the control valve, and a second hand grip zone located adjacent to the discharge ports in the lower end; and
at least one of the hand grip zones having an insulation covering for optimum safe control of the tool in use.

2. The cleaning tool of claim 1, in which the insulation covering is applied to cover and protect the first hand grip zone.

3. The cleaning tool of claim 1, in which the insulation covering is applied to cover and protect the second hand grip zone.

4. The cleaning tool of claim 1, in which the insulation covering is applied to cover and protect both the first and second hand grip zones.

5. The cleaning tool of claim 4, in which the insulation covering is applied to cover the length of the body member between the hand grip zones and thereby extend these protected zones toward each other.

6. The cleaning tool of claim 1, in which the insulation covering is constructed and arranged to protect against electrical shock.

7. The cleaning tool of claim 7, in which the insulation covering is constructed of a plastic material applied as a coating over the at least one hand grip zone of the body member.

8. The cleaning tool of claim 1, in which the at least one hand grip zone and its insulation covering extend a substantial length of the body member to thereby accommodate variable user hand positioning on the tool.

9. The cleaning tool of claim 8, wherein said insulation covering on said at least one hand grip zone has a continuous smooth exterior surface.

10. A cleaning tool comprising:
a body member having a circular upper section with an intake end having a control valve for attachment to a pressurized source of cleaning fluid, and a long, thin lower section with a closed lower end having a plurality of adjacent fluid jet discharge ports therein,
said body member having an upper primary hand grip zone in the rounded upper section adjacent to the control valve, and a lower secondary hand grip zone located along the lower section adjacent to the discharge ports, and
insulation covering constructed and arranged to cover and protect the upper and lower hand grip zones for optimum safe control of the tool in use.

11. The cleaning tool of claim 10, in which the insulation covering is applied to cover the length of the body member between the hand grip zones and thereby extend these protected zones toward each other.

12. The cleaning tool of claim 10, in which the insulation covering is constructed and arranged to protect against electrical shock.

13. The cleaning tool of claim 12, in which the insulation covering is constructed of a plastic material applied as a coating over the body member.
